(19) United States
(12) Patent Application Publication
(10) Pub. No.: US 2005/0202951 A1
(43) Pub. Date: Sep. 15, 2005

(54) Method of making float glass

(75) Inventors: Richard Hulme, Rochester Hills, MI (US); Anthony V. Longobardo, Oak Grove, MI (US)

Correspondence Address: NIXON & VANDERHYE, PC, 901 NORTH GLEBE ROAD, 11TH FLOOR, ARLINGTON, VA, 22203, US

(73) Assignee: Guardian Industries Corp., Auburn Hills, MI (US)

(21) Appl. No.: 11/079,523

(22) Filed: Mar. 15, 2005

Related U.S. Application Data
(60) Provisional application No. 60/552,751, filed on Mar. 15, 2004.

(51) Int. Cl. C03C 3/087

(52) U.S. Cl. 501/70; 65/99.2

(57) ABSTRACT

Soda-lime-silica based glass is provided so as to have an improved (i.e., reduced USPX value). In certain example embodiments, the USPX value may be reduced in a desirable manner by reducing alumina and sodium content, while increasing content of material(s) such as MgO and/or CaO. The lower the USPX value, the better the stain resistance of the glass.

This application claim priority on U.S. Provisional Application No. 60/552,751, filed Mar. 15, 2004, the entire disclosure of which is hereby incorporated herein by reference.

This invention relates to methods of making glass compositions, and glasses resulting from the same. More particularly, this invention relates to a method of making a glass having an improved (i.e., lower) USPX value so as to have improved durability and stain resistance, and/or an improved (i.e., lower) cool time. Such glass compositions are useful, for example, in architectural windows, patterned glass applications, solar cells, and/or automotive windows.

### BACKGROUND OF THE INVENTION

It is known to make glass via the float process using a molten bath such as a tin bath. For example, see U.S. Pat. Nos. 5,932,502; 6,235,666, 6,521.558, 6,610,622 and 5,214,008, the disclosures of which are hereby incorporated herein by reference.

It has been found that the USPX value/number of a glass is a good indictor of actual durability (e.g., stain resistance) of the glass as determined by accelerated weathering tests. The lower the USPX value, the more durable the glass and the more resistant the glass is to staining.

The term USPX is derived from Unites States Pharmacopeia (USP). In this regard, chemical durability (e.g., sodium leaching) is an area of concern and standards have been defined for measuring glass performance in this regard. In particular, ASTM C225-85, the disclosure of which is hereby incorporated herein by reference, (method P-W) discloses the technique for determining USPX values for glass. Generally speaking, ASTM C225-85 (Reapproved 1999) defines a straightforward method to measure the chemical resistance of glass in terms of USPX. The quantity of ground glass powder is immersed in 50 ml of DI water, placed in an autoclave and held at a specified temperature (121 degrees C.) for a specified time schedule. The resultant solution is titrated to determined the amount (ml) of 0.020N H₂SO₄ needed to neutralized the extracted soda. The USPX number/value is the amount of acid added, reported in fractions milliliters. A lower volume of leached soda requires a low volume of acid; a low value of USPX is indicative of greater chemical resistance.

Float glass when actually measured typically has a USPX value of 7.0 or higher. Unfortunately, over a period of days glass can be susceptible to severe staining at USPX values of 7.0 or higher.

In view of the above, it will be appreciated by those skilled in the art that there exists a need for a glass made via the float process that is less susceptible to staining (i.e., which has a lower USPX value/number).

### SUMMARY OF EXAMPLE EMBODIMENTS OF INVENTION

An object of this invention is to provide a glass made via the float process that has improved durability, in particular a lower USPX value.

In certain example embodiments of this invention, the glass may also have a reduced cooling time, which has surprisingly been found to improve (i.e., reduce) USPX values.

In certain example embodiments of this invention, soda-lime-silica based glass, made via the float process, has a USPX value of no greater than 6.2, more preferably no greater than 6.1, and most preferably no greater than 6.0. The lower the USPX value, the better the stain resistance and thus durability of the glass.

It has unexpectedly been found that lowering or reducing the setting or cooling time of float glass helps reduce the USPX value/number of the glass. In certain example embodiments of this invention, soda-lime-silica based glass, made via the float process, has a cooling or setting time of no greater than 100.0 seconds, more preferably no greater than 95.5 seconds.

Surprisingly, it has been found that reducing the alumina (Al₂O₃) content and reducing the soda ash (e.g., Na₂O) content of soda-lime-silica based float glass allows the USPX vales to be reduced. This in turn translates into improved durability (e.g., less staining) and thus improved yields. Reduced alumina also permits costs to be reduced.

In certain example embodiments of this invention, there is provided a glass comprising:

| Ingredient | wt. % |
|---|---|
| SiO₂ | 67-75% |
| Na₂O | <=13% % |
| CaO | 5-15% |
| Al₂O₃ | <=1.0% |
| MgO | 1-8% |
| total iron (expressed as Fe₂O₃) | 0.01 to 1.0% |

wherein the glass has a USPX value of less than or equal to 6.25 (or less than or equal to 6.0 in certain example embodiments).

In other example embodiments of this invention, there is provided a method of making glass, comprising: melting a glass batch in a furnace; and forwarding the melt via a tin bath via a float process so as to form a soda lime silica based glass having a USPX value of less than or equal to 6.25 and a setting time of less than or equal to 100 seconds.

### IN THE DRAWINGS

FIG. 1 is a graph plotting stain susceptibility for glass versus USPX number.

### DETAILED DESCRIPTION OF CERTAIN EMBODIMENTS OF THIS INVENTION

Glasses according to different embodiments of this invention may be used, for example, in the automotive industry (e.g., windshields, backlites, side windows, etc.), in architectural window applications, for patterned glass applications, solar cell applications, and/or in other suitable applications.

Certain glasses according to example embodiments of this invention utilize soda-lime-silica flat glass as their base composition/glass. In addition to base composition/glass, a unique colorant portion may be provided in order to achieve a glass that is fairly clear and/or colored, and which may optionally have a high visible transmission (e.g., at least 70% in certain example instances).

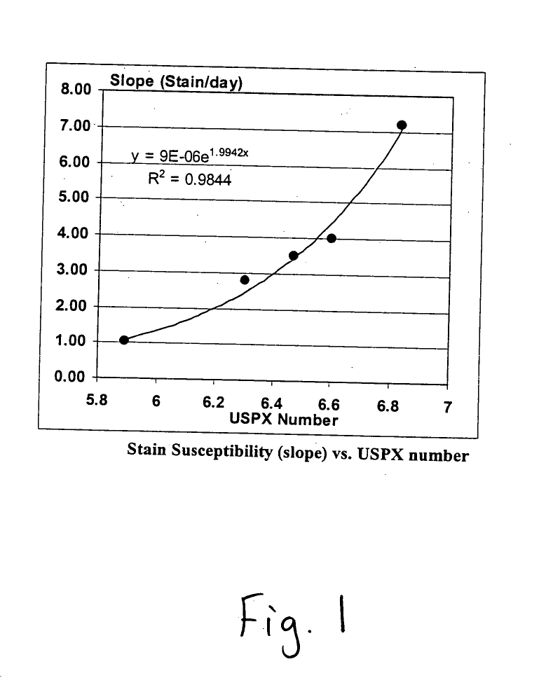

In certain example embodiments of this invention, a glass made via the float process that has improved durability, in particular a lower USPX value. In certain example embodiments of this invention, the glass may also have a reduced cooling time, which has surprisingly been found to improve (i.e., reduce) USPX values in certain example embodiments of this invention. In certain example embodiments of this invention, soda-lime-silica based glass, made via the float process, has a USPX value of no greater than 6.25, more preferably no greater than 6.20, more preferably no greater than 6.1, and most preferably no greater than 6.0. The lower the USPX value, the better the stain resistance and thus durability of the glass (see FIG. 1).

It has unexpectedly been found that lowering or reducing the setting or cooling time of float glass helps reduce the USPX value/number of the glass. In certain example embodiments of this invention, soda-lime-silica based glass, made via the float process, has a cooling or setting time of no greater than 100.0 seconds, more preferably no greater than 95.5 seconds.

Surprisingly, it has been found that reducing the alumina (Al₂O₃) content and reducing the soda ash (e.g., Na₂O) content of soda-lime-silica based float glass allows the USPX vales to be reduced. This in turn translates into improved durability (e.g., less staining) and thus improved yields. Reduced alumina also permits costs to be reduced. It has unexpectedly been found that lower alumina content alone causes the USPX value to increase (not decrease) and is therefore undesirable because a less durable glass results. However, it has unexpectedly been found that lowering both the alumina (Al₂O₃) content and the soda ash (e.g., Na₂O) content of soda-lime-silica based float glass together causes the USPX value to decrease, without causing adverse melting or operation issues to arise.

In certain example embodiments of this invention, for soda-lime-silica based glass made via the float process, it has been surprisingly found that the combination of: (a) an alumina (Al₂O₃) content of from 0 to 1%, more preferably from 0 to 0.50%, and most preferably from 0 to 0.25%; and (b) a Na₂O content of no greater than 13.0%, more preferably no greater than 12.80%, permits a reduce USPX value and a reduced cool time to be realized. This allows costs to be reduced due to less alumina while simultaneously causing durability to be increased.

In certain example embodiments of this invention, as Na₂O content is decreased, MgO and/or CaO content can be increased to maximize the decrease in cooling time. In certain example embodiments of this invention, the ratio of Na₂O/(CaO+MgO) is less than or equal to 0.90, more preferably less than or equal to 0.85, and most preferably less than or equal to 0.80.

In certain example embodiments of this invention, during the process of making float glass according to certain example embodiments of this invention, the viscosity of the glass during the float process decreases from log η=3.0 poise to log η=7.65 poise in less than or equal to 100 seconds, more preferably in less than or equal to 99.5 seconds. This is indicative to a quicker setting or cooling time of the glass, which in turn surprisingly helps lower USPX values to be achieved.

An exemplary soda-lime-silica glass according to certain embodiments of this invention, on a weight percentage basis, includes the following basic ingredients:

Example Glass Composition

| Ingredient | Wt. % |
|---|---|
| SiO₂ | 67-75% |
| Na₂O | <=13% (or <=12.80%) |
| CaO | 5-15% |
| MgO | 0-8% (or 5-7%) |
| Al₂O₃ | <=1% (or <=0.5 or <=0.25%) |
| K₂O | 0-5% |

Other ingredients, including various conventional colorants such as iron, cobalt, selenium, and/or refining aids, such as SO₃, carbon, and the like may also be included in the base glass. In certain embodiments, for example, glass herein may be made from batch raw materials silica sand, soda ash, dolomite, limestone, with the use of salt cake (SO₃) and/or Epsom salts (e.g., about a 1:1 combination of both) as refining agents.

Transmissive Characteristics of Example Embodiments

| Characteristic | General | More Preferred | Most Preferred |
|---|---|---|---|
| Lta (Ill. C, 2 deg.): | >=70% | >=85% | >=90% |
| L* (Ill. D65, 10 deg.): | 90-100 | n/a | n/a |
| a* (Ill. D65, 10 deg.): | −3 to +3.0 | −1.0 to +1.0 | −0.8 to +0.50 |
| b* (Ill. D65, 10 deg.): | −5.0 to +5.0 | −0.7 to +1.0 | 0 to +0.5 |

### EXAMPLE

An example glass of this invention made using the known float process, and its chemical makeup is set forth below. The amounts of the various materials set forth below are listed in terms of weight percentage (%) in the glass, unless otherwise indicated.

### EXAMPLE

| Ingredient | Wt. % |
|---|---|
| SiO₂ | 71.38% |
| Na₂O | 12.76% |
| CaO | 9.73% |
| MgO | 5.42% |
| Al₂O₃ | 0.43% |
| K₂O | 0.07% |
| TiO₂ | 0.03% |
| SO₃ | 0.16% |
| Fe₂O₃ | 0.03% |

The aforesaid example glass had a cool time of about 100 seconds and a USPX value of less than 6.25. Thus, improved durability was achieved.

Once given the above disclosure many other features, modifications and improvements will become apparent to the skilled artisan. Such features, modifications and improvements are therefore considered to be a part of this invention, the scope of which is to be determined by the following claims:

1. Glass comprising:

| Ingredient | wt. % |
|---|---|
| SiO₂ | 67-75% |
| Na₂O | <=13% % |
| CaO | 5-15% |
| Al₂O₃ | <=1.0% |
| MgO | 1-8% |
| total iron (expressed as Fe₂O₃) | 0.01 to 1.0% |

wherein the glass has a USPX value of less than or equal to 6.25.

2. The glass of claim 1, wherein the glass comprises from 5-7% MgO.

3. The glass of claim 1, wherein the glass has a USPX value of less than or equal to 6.0.

4. The glass of claim 1, wherein the glass has a cooling time of less than or equal to 100 seconds.

5. The glass of claim 1, wherein a ratio of Na₂O/(CaO+MgO) is less than or equal to 0.90.

6. The glass of claim 1, wherein a ratio of Na₂O/(CaO+MgO) is less than or equal to 0.85.

7. The glass of claim 1, wherein a ratio of Na₂O/(CaO+MgO) is less than or equal to 0.80.

8. A method of making glass, comprising:
melting a glass batch in a furnace;
forwarding the melt via a tin bath via a float process so as to form a soda lime silica based glass having a USPX value of less than or equal to 6.25 and a setting time of less than or equal to 100 seconds.

9. The method of claim 8, wherein the glass has a USPX value of less than or equal to 6.0.

10. The method of claim 8, wherein the glass has a cooling or setting time of no greater than 95.5 seconds.

11. The method of claim 8, wherein a ratio of Na₂O/(CaO+MgO) in the glass is less than or equal to 0.90.

12. The method of claim 8, wherein a ratio of Na₂O/(CaO+MgO) in the glass is less than or equal to 0.85.

13. The method of claim 8, wherein a ratio of Na₂O/(CaO+MgO) in the glass is less than or equal to 0.80.

14. The method of claim 8, wherein during making of the glass, viscosity of the glass decreases from log η=3.0 poise to log η=7.65 poise in less than or equal to 100 seconds.

15. The method of claim 8, wherein during making of the glass, viscosity of the glass decreases from log η=3.0 poise to log η=7.65 poise in less than or equal to 99.5 seconds.

16. The method of claim 8, wherein the glass comprises from 5-7% MgO.
